(19) United States
(12) Patent Application Publication
(10) Pub. No.: US 2023/0070299 A1
(43) Pub. Date: Mar. 9, 2023

(54) GLASS UNIT FOR AN ILLUMINATED VEHICLE ROOF, METHOD OF MANUFACTURING A GLASS UNIT, AND ILLUMINATED VEHICLE ROOF

(71) Applicant: Roof Systems Germany GmbH, Dietzenbach (DE)

(72) Inventors: Joachim ROEDER, Dietzenbach (DE); Tobias THEOBALD, Dietzenbach (DE); Ahmet TEKIN, Dietzenbach (DE)

(21) Appl. No.: 17/898,542

(22) Filed: Aug. 30, 2022

(30) Foreign Application Priority Data
Aug. 31, 2021 (DE) 10 2021 122 494.2

(51) Int. Cl. B60Q 3/208; B60J 1/00; G02B 5/20; F21V 8/00; B32B 17/10; B32B 7/023

(52) U.S. Cl. CPC B60Q 3/208; B60J 1/001; G02B 5/208; G02B 6/009; B32B 17/10018; B32B 17/1077; B32B 7/023; B32B 17/10449; B32B 17/1011; B32B 17/10495; B32B 17/10899; B32B 2605/006; B32B 2307/412; B32B 2307/418

(57) ABSTRACT

A glass unit for an illuminated vehicle roof including a glass pane, a glass primer layer, and a polyurethane layer. The glass pane is provided, on one side, with the glass primer layer, wherein a polyurethane layer is in turn applied to the glass primer layer.

### FIELD OF THE INVENTION

The invention relates to a glass unit for an illuminated vehicle roof, to a method of manufacturing a glass unit, and to an illuminated vehicle roof.

### BACKGROUND OF THE INVENTION

The requirements for vehicle roofs have changed significantly in recent years. An improved interior ambiance is increasingly demanded by the market, wherein an important step for enhancing the interior ambience has been taken by introducing illuminated vehicle roofs.

These illuminated glass roofs are often configured as sliding roofs and comprise a laminated glass pane as a semi-finished product for manufacturing the illuminated glass roof. A common embodiment of such a laminated glass pane is a laminated safety glass with the arrangement sequence glass pane/plastic film/glass pane.

Instead of the laminated glass pane, illuminated glass roofs having a single glass pane provided with a layer, for example a polyurethane layer, are also known. This permits a lighter and more compact structure compared to a laminated safety glass.

Furthermore, illuminated glass roofs comprise a frame in which luminous elements are attached which illuminate the glass pane of the laminated safety glass facing the vehicle interior or the polyurethane layer attached to the single glass pane.

However, the known illuminated glass roofs having a single glass pane and a polyurethane layer attached thereto have the drawback that the polyurethane layer adheres poorly to the glass pane and the polyurethane layer detaches from the glass pane already during manufacture of the vehicle roof or in the course of operation of the vehicle. The vibrations introduced during operation of the vehicle further promote this negative effect.

It is therefore the object of the present invention to provide an illuminated vehicle roof which is light compared to the prior art and at the same time has a long durability.

### SUMMARY OF THE INVENTION

According to the invention, the object is achieved by a glass unit for an illuminated vehicle roof, comprising a glass pane, a glass primer layer, and a polyurethane layer. The glass pane is provided, on one side, with the glass primer layer, the polyurethane layer being applied to this glass primer layer.

The above-mentioned structure of the glass unit is therefore

very light as only a single glass pane is installed. Furthermore, the relatively light polyurethane layer which can be configured to be thin increases the thickness of the glass unit only slightly. In addition, the glass primer layer serves as an adhesion agent between the glass pane and the polyurethane layer.

The glass primer is in particular characterized by improving the wetting properties and the adhesion to the glass pane and thus simplifying the manufacture and enabling a reliable bonding.

According to one aspect of the invention, the glass primer layer has a lower refractive index than the adjacent polyurethane layer. Due to the refractive index of the glass primer layer which is lower than the refractive index of the adjacent polyurethane layer, light incident from the side can be efficiently guided into and along the polyurethane layer.

Advantageously, the glass primer layer is provided at at least one local point with a scattering structure configured so as to scatter incident light. The advantage here is the purposeful outward conduction of the light. Any shape predefined by the manufacturer or any pattern having multiple shapes may be applied to the vehicle roof and can be made visible by illuminating the vehicle roof.

According to one embodiment, the glass pane is tempered glass, in particular a single-pane safety glass. This increases the breaking resistance of the glass unit and offers better protection for occupants of the vehicle. Furthermore, rejects may be reduced in the manufacture by using a single-pane safety glass.

According to one aspect of the invention, the glass pane is a tinted glass, in particular a gray glass or a green glass. By selecting an appropriately tinted glass pane, the interior ambience can be further positively influenced. For example, less sunlight enters the vehicle interior as a result of this measure. In addition, the vehicle occupants can be protected from unfamiliar glances from outside the vehicle.

A further advantage is that an illuminated scattering structure on the vehicle roof is also visible in daylight, as the contrast of the illuminated scattering structure to the immediate surroundings thereof is increased.

A further aspect of the invention provides that the polyurethane layer is transparent. A transparent polyurethane layer favors light conduction as less light is absorbed. The illuminated vehicle roof thus shines more brightly.

In addition, the polyurethane layer configured to be transparent simplifies the production process for the glass unit. For example, glass panes having different tinting levels can be used to produce glass units having different tinting levels. As a result, sunlight entering from the surroundings of the vehicle is reduced only by the possibly tinted glass pane.

Advantageously, the polyurethane layer is configured such that ultraviolet and infrared rays incident on the polyurethane layer are not transmitted. This provides better protection of UV-sensitive vehicle occupants from ultraviolet light from the sun than is already the case with ordinary glass. In addition, protection is provided against infrared rays from the sun incident on the vehicle. As a result, the vehicle interior heats up less.

According to a further configuration, the polyurethane layer is provided at at least one local point with a scattering structure which is configured so as to scatter incident light. As in the case of a scattering structure on the glass primer layer, a scattering structure in the polyurethane layer can also be used to achieve a purposeful outward conduction of the light, wherein the outward conduction of the light can also take place here on a predefined shape or on any pattern having multiple shapes. In particular, the scattering structure in the polyurethane layer is an incorporated laser engraving.

Furthermore, the invention relates to an illuminated vehicle roof comprising a glass unit according to the invention as described above and a frame surrounding the glass unit, to which at least one luminous element is attached, the luminous element being arranged on an end face of the glass unit such that the light from the luminous element can be coupled into the polyurethane layer in a planar manner. The light coupled in can be guided through the polyurethane layer, which serves as a light guide therefor. This is particularly efficient because the light is reflected several times at the boundary surfaces of the polyurethane layer and is thus redirected in the direction of the scattering structure. This increases the brightness of the illuminated scattering structure.

Advantageously, the frame comprises an opaque polyurethane material in the area of the attached luminous element. Due to this configuration, the light is directed exclusively into the polyurethane layer. As a result, the luminous element is perceived as less disturbing by a vehicle occupant, as no light can enter the vehicle interior via the frame. In other words, this measure leads to a further improvement of the vehicle interior ambience.

According to one embodiment, conducting tracks are incorporated in the frame, and the at least one luminous element is configured as a luminous unit, wherein the luminous unit comprises a printed circuit board having plug contacts and a light-emitting diode (LED) attached to the printed circuit board. The luminous unit is furthermore clipped into the frame, and the plug contacts are electrically connected to the conducting tracks. Thus, the luminous element is configured in a modular manner as a luminous unit so that it can be replaced very easily. This ensures interchangeability, so that it is not necessary to replace the complete illuminated vehicle roof in the event of a technical defect.

The object is also achieved by a method of manufacturing a glass unit, in particular of manufacturing a glass unit as described above, for an illuminated vehicle roof, wherein the method comprises the following steps:
provision of a glass pane;
application, in particular automated application of a glass primer layer onto a first surface of the glass pane; and
application of a polyurethane layer onto the glass primer layer.

The described method favors bonding of the polyurethane to the glass pane by achieving improved adhesion between the glass pane and the polyurethane layer through the applied glass primer layer.

The automated application of the glass primer layer also prevents streaking and irregularities in the application of the glass primer layer, which improves the aesthetics of the illuminated glass roof.

One aspect of the invention provides that the glass pane is cleaned, in particular thermally or by means of an adhesive cleaner, at least on the first surface thereof prior to the application of the glass primer layer. This has the advantage that the glass primer layer adheres better to the glass pane, as a result of which finally, also the polyurethane layer is bonded more reliably to the glass pane via the glass primer layer.

According to one embodiment of the method, a scattering structure which scatters incident light is incorporated into the polyurethane layer by means of a laser in a further step. The laser is a cost-effective means for incorporating a scattering structure, no additional materials being required. In addition, the laser allows a high cycle time in production, which in turn results in only low costs.

### BRIEF DESCRIPTION OF THE DRAWINGS

The invention is explained below on the basis of various example embodiments, which are described with reference to the accompanying drawings, in which:

FIG. 1 shows a laminated safety glass according to the prior art in a cross-section;

FIG. 2 shows an illuminated vehicle roof according to the invention in accordance with one embodiment in a cross-section;

FIG. 3 shows an illuminated vehicle roof according to the invention in accordance with a further embodiment in a plan view;

FIG. 4 shows a luminous element of the illuminated vehicle roof according to FIG. 3 in a plan view, the luminous element being configured as a luminous unit; and

FIG. 5 shows a detail of the illuminated vehicle roof of FIG. 3.

### DETAILED DESCRIPTION OF THE INVENTION

Illuminated vehicle roofs belong to the prior art and are intended to improve the interior ambience of a vehicle. A predefined pattern, which was introduced into the vehicle roof during manufacture, is made visible by being illuminated. Known scattering structures are for example applied to the illuminated vehicle roof as a ceramic print pattern.

Thus, it is possible that a starry sky is simulated by the known technique with the illumination of a vehicle roof provided with a star pattern, for example, and thus that the interior ambience of the vehicle is improved.

Already known illuminated vehicle roofs mostly comprise a plurality of integrated luminous elements which illuminate the pattern predefined by the manufacturer, which is formed as a scattering structure in the vehicle roof, the light emitted by the luminous elements which strikes the scattering structure radiating into the interior of the vehicle.

Semi-finished products used in a standard manner such as laminated safety glasses having partially tempered glasses are known from the prior art for the manufacture of illuminated vehicle roofs.

It should be noted here that illuminated vehicle roofs made of glass belong to the so-called overhead glazing. Overhead glazing must provide a high level of safety for the occupants of the car to protect the occupants in the event of an accident and, in particular, not to put them in an even more dangerous situation, for example, due to flying splinters.

When partially tempered glass is used in laminated safety glasses, large-sized coherent fragments are produced which still have a high residual load-bearing capacity in the event of breakage, e.g. as a result of a car accident. In particular, laminated safety glasses do not shatter completely because they are held together by an elastic composite material.

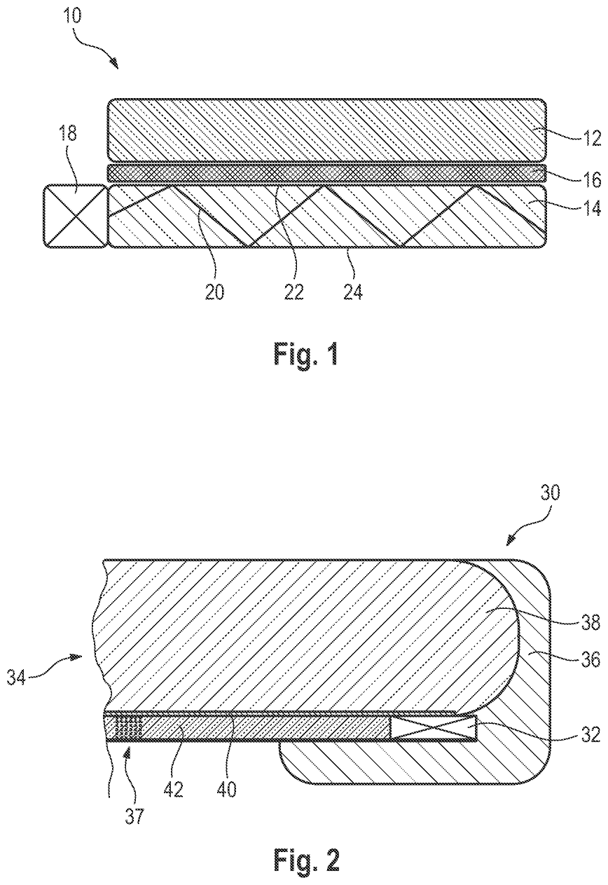

FIG. 1 shows an exemplary structure of such a laminated safety glass 10 according to the prior art, which is used as standard in many illuminated vehicle roofs.

The laminated safety glass 10 of an illuminated glass roof is composed of an upper glass pane 12 facing away from the vehicle interior, a lower glass pane 14 facing the vehicle interior, and a plastic film 16 therebetween, the plastic film 16 being the elastic composite material described above. The two outer glass panes 12, 14 are connected to each other by an intermaterial bond by means of a lamination process with exposure to pressure and heat.

The plastic film 16 has two functions in illuminated vehicle roofs of the prior art. On the one hand, it is highly tear-resistant for the safety of the occupants and has viscoelastic properties, and on the other hand, it ensures that the light introduced by the luminous elements is held inside the lower glass pane 14 of the laminated safety glass 10 by a number of reflections. Thus, the lower glass pane 14 acts as a kind of light guide.

Light is introduced laterally into the laminated safety glass 10 of the vehicle roof and is reflected several times at the boundary surfaces of the lower glass pane 14. FIG. 1 shows to this end a luminous element 18, in this case a light emitting diode (LED), next to the laminated safety glass 10, as well as the reflected beam path 20 of a light beam drawn by way of example.

Two boundary surfaces 22, 24 are responsible for the reflection in the lower glass pane 14. One is located between the lower glass pane 14 and the plastic film 16, and the second is located between the lower glass pane 14 and the vehicle interior, which is known to be filled with air.

The plastic film 16 and the air-filled vehicle interior have a lower refractive index than the adjacent lower glass pane 14, which is why the light beam is at least partially reflected.

The structure of a vehicle roof 30 according to the invention is shown in FIG. 2. The vehicle roof 30 comprises a plurality of luminous elements 32, a glass unit 34 according to the invention, and a frame 36 surrounding the glass unit 34.

The luminous elements 32 serve to introduce light into the vehicle roof, wherein for this purpose, the luminous elements 32 are arranged distributed on the end faces of the glass unit 34.

Due to the light elements 32 arranged laterally on the end face of the glass unit 34, the emitted light thereof is introduced into the glass unit 34 in a planar manner. Subsequently, the light is efficiently guided to a scattering structure 37 located in the glass unit 34, which scatters the introduced light beams into the vehicle interior.

The glass unit 34 according to the invention comprises a glass pane 38, in this case a single-pane safety glass, a glass primer layer 40, for example a layer of Chemlok-144, and a transparent polyurethane layer 42 (PU/PUR layer). The glass primer layer 40 is applied to one side of the glass pane 38 and is adhered thereto. The polyurethane layer 42 is in turn firmly connected to the glass primer layer 40.

As a result of the described structure of the glass unit 34, less installation space is required on the vehicle compared to a laminated safety glass 10, since a second glass pane is not required. In addition, the glass primer layer 40 enables a reliable adhesive bond between the polyurethane layer 42 and the glass pane 38.

More specifically, the previously described light introduced in a planar manner and introduced into the glass unit 34 is introduced into the polyurethane layer 42 of the glass unit 34 and is then directed to the scattering structure 37.

In the present example embodiment, the scattering structure 37 is incorporated into the polyurethane layer 42 of the glass unit 34. However, it is also conceivable that a scattering structure 37 is alternatively or additionally applied to the primer layer 40, in particular printed thereon.

The adjacent glass primer layer 40 fulfills a further function in addition to that of an adhesive agent. For example, the material of the glass primer layer was selected such that the refractive index thereof is lower than the refractive index of the adjacent polyurethane layer. If light were introduced into a polyurethane layer directly adjacent to the glass pane 38, light could escape into the glass pane 38 without being reflected at the boundary surface.

In contrast to the known prior art according to FIG. 1, the light is introduced into the polyurethane layer 42 in a planar manner and not into the lower glass pane 14, and further transmitted there. The multiple reflections described above at the boundary surfaces 22, 24 of the lower glass pane 14 now occur analogously at the boundary surfaces of the polyurethane layer 42.

In the present example embodiment, the glass pane 38 of the glass unit 34 according to the invention is a gray glass which has a refractive index of about 1.52. The transparent polyurethane layer 42 also has a refractive index of about 1.52, and the glass primer layer 40 has a lower refractive index than the adjacent polyurethane layer 42.

By these indicated refractive indices and the previously described structure of the glass unit 34, it is apparent that light can be redirected similarly to the known prior art structure according to FIG. 1.

The polyurethane layer 42 of the glass unit 34 primarily serves to guide light in the glass unit 34. Furthermore, it can also serve to protect the vehicle occupants from ultraviolet and infrared radiation from the sun.

For this purpose, the polyurethane layer 42 is specially designed so that it at least partially shields ultraviolet and infrared radiation. As a result, the vehicle interior heats up less and sun-sensitive occupants can be better protected from the harmful ultraviolet radiation. This can be achieved, for example, by mixing additives into the starting material of the polyurethane layer 42, such as a viscous polyurethane starting material.

In order to be able to provide good protection to the occupants of a vehicle having a vehicle roof according to the present invention in the event of an accident, a single-pane safety glass may be used as the glass pane 38, as in the present example embodiment.

The frame 36 of the illuminated vehicle roof 30 is made of black polyurethane. Its function is to hold the illuminated vehicle roof 30 together as a unit. To this end, it accommodates the luminous elements 32 and the glass unit 34.

In addition, the frame 36 is provided with conducting tracks which conduct electrical energy to the luminous elements 32. The conducting tracks are in turn connected to a source of electrical energy.

During manufacture, the frame 36 can be produced by foaming around the glass unit 34, wherein the conducting tracks and the luminous elements 32 are simultaneously foamed into the frame 36.

The luminous elements 32 are incorporated into the frame 36 such that the light from the luminous elements 32 can be coupled in a planar manner into the polyurethane layer 42. At the same time, the light from the luminous elements 32 does not radiate through the frame 36 because the black polyurethane of the frame 36 is opaque. Thus, there is an isolated introduction of light.

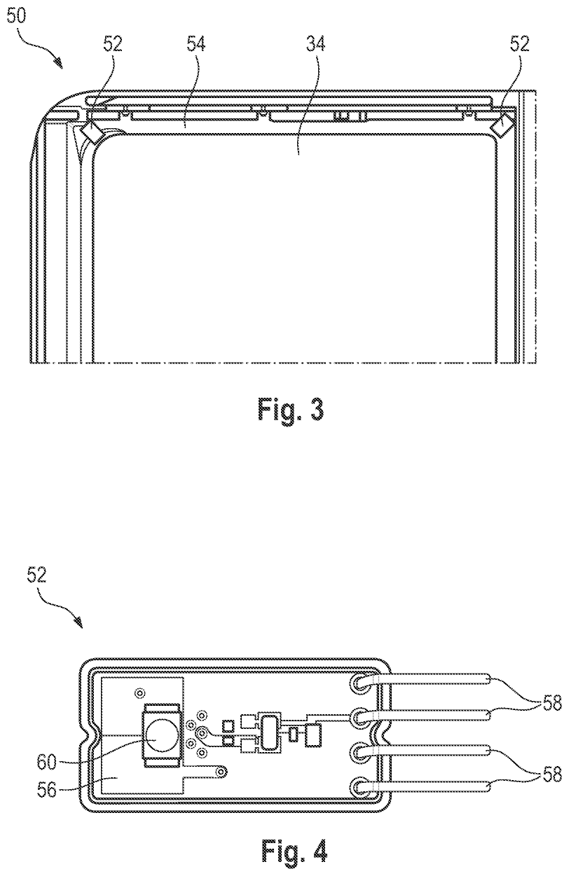

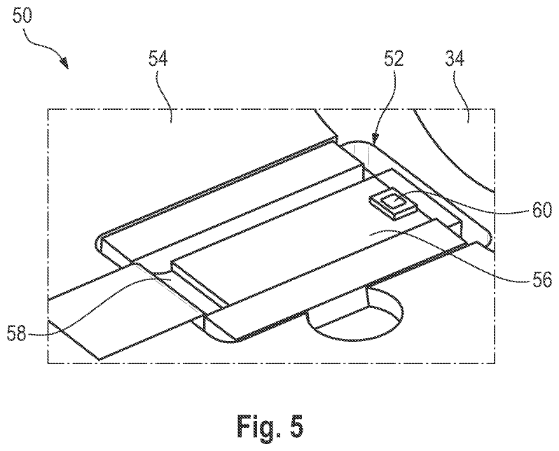

The further embodiment of a vehicle roof 50 according to the invention illustrated in FIGS. 3 and 5 differs from the embodiment described above in that the luminous elements 32 are configured as luminous units 52 and are attached to the frame 54 in a special manner.

These luminous units 52 each comprise a printed circuit board 56 having plug contacts 58 and a light emitting diode 60 (LED) attached to the printed circuit board 56, as can be seen in FIG. 4.

A possible positioning of the luminous units 52 in the frame 54 is shown in FIG. 3 only exemplary, the luminous units 52 being mounted in the corners of the rectangularly designed vehicle roof 50.

As described previously for the embodiment according to FIG. 2, the frame 54 of the embodiment according to FIG. 3 is also provided with conducting tracks, wherein in the mounted state, the plug contacts 58 of the luminous units 52 are electrically connected to the conducting tracks. In contrast to the embodiment according to FIG. 2, only the conducting tracks are foamed into the frame 54, but not the luminous units 52.

In the following, the associated method according to the invention of manufacturing a glass unit 34 is explained with reference to FIG. 2.

To manufacture the glass unit 34, the glass pane 38 is first provided in a desired shape and size.

Subsequently, at least a first surface of the glass pane 38 is cleaned with an adhesive cleaner in order to remove any contamination, in particular oil films, which would significantly reduce the adhesion of the glass primer layer 40 to the glass pane 38. The adhesive cleaners used for this purpose are usually solvent-containing liquids, for example on the basis of alcohol or acetone. This process is also referred to as adhesion activation, the adhesive cleaner is also referred to as an adhesion activator.

Alternatively, a thermal cleaning of the glass pane 38, for example with a flame, is also conceivable.

A glass primer layer 40 is then applied to the first surface of this glass pane 38 in an automated manner, with particular care being taken to ensure that the glass primer layer 40 is applied evenly and that no streaking occurs, which would negatively affect the visual appearance of the glass unit 34.

Subsequently, the polyurethane layer 42 is applied evenly and in a planar manner onto the glass primer layer 40.

After subsequent curing of the polyurethane layer 42 applied in viscous form, the finished glass unit 34 is ready.

The scattering structure 37 can then be applied to the polyurethane layer 42 of this glass unit 34 by a laser. In this case, the scattering structure 37 is a type of laser engraving. However, it is also conceivable that the scattering structure 37 is applied or incorporated by another technique, for example by a ceramic printing process.

1. A glass unit for an illuminated vehicle roof, comprising a glass pane, a glass primer layer, and a polyurethane layer, wherein the glass pane is provided, on one side, with the glass primer layer and the polyurethane layer is applied to this glass primer layer.

2. The glass unit of claim 1 wherein the glass primer layer has a lower refractive index than an adjacent polyurethane layer.

3. The glass unit of claim 1 wherein the glass primer layer is provided at at least one local point with a scattering structure configured to scatter incident light.

4. The glass unit of claim 1 wherein the glass pane is a tempered glass, in particular a single-pane safety glass.

5. The glass unit of claim 1 wherein the glass pane is a tinted glass, in particular a gray glass or a green glass.

6. The glass unit of claim 1 wherein the polyurethane layer is transparent.

7. The glass unit of claim 1 wherein the polyurethane layer is configured such that ultraviolet and infrared rays incident on the polyurethane layer are not transmitted.

8. The glass unit of claim 1 wherein the polyurethane layer is provided at at least one local point with a scattering structure configured to scatter incident light.

9. An illuminated vehicle roof comprising a glass unit with a glass pane, a glass primer layer, and a polyurethane layer, wherein the glass pane is provided, on one side, with the glass primer layer and the polyurethane layer is applied to this glass primer layer, and further comprising a frame which surrounds the glass unit and to which at least one luminous element is attached, the luminous element being arranged on an end face of the glass unit such that light of the luminous element can be coupled into the polyurethane layer in a planar manner.

10. The illuminated vehicle roof of claim 9 wherein the frame comprises an opaque polyurethane material in an area of the attached luminous element.

11. The illuminated vehicle roof of claim 9 wherein conducting tracks are incorporated in the frame and the at least one luminous element is configured as a luminous unit, wherein the luminous unit comprises a printed circuit board having plug contacts and a light-emitting diode (LED) attached to the printed circuit board, and wherein the luminous unit is clipped into the frame and the plug contacts are electrically connected to the conducting tracks.

12. A method of manufacturing a glass unit for an illuminated vehicle roof, wherein the method comprises the following steps:
provision of a glass pane;
application, in particular automated application of a glass primer layer onto a first surface of the glass pane; and
application of a polyurethane layer onto the glass primer layer.

13. The method of claim 12 wherein the method comprises a further step in which the glass pane is cleaned, in particular thermally or by means of an adhesive cleaner, at least on the first surface thereof prior to the application of the glass primer layer.

14. The method of claim 12 wherein the method comprises a further step in which a scattering structure which scatters incident light is incorporated into the polyurethane layer by means of a laser.
